(19) United States
(12) Patent Application Publication
(10) Pub. No.: US 2006/0280147 A1
(43) Pub. Date: Dec. 14, 2006

(54) Wireless communications system

(75) Inventors: Khurram Ali Rizvi, Bristol (GB); Yuk Ching Chow, Bristol (GB); Dharmayashdev Rai Basgeet, Bristol (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/412,942

(22) Filed: Apr. 28, 2006

(30) Foreign Application Priority Data
Jun. 2, 2005 (GB) 0511281.8

(51) Int. Cl. H04B 7/216

(52) U.S. Cl. 370/335

(57) ABSTRACT

A communication network comprises at least a first region serviced by a base station. This region also comprises a plurality of bridging stations deployed around the base station, so defining a circumference around it. Each bridging station comprises one or more directional antennas operable to generate a coverage area lying predominantly outside said circumference. The effect is to form, in operation, an outer zone predominantly outside said circumference serviced by said bridging stations, and an inner zone within said circumference serviced by said base station. For communications with the outer zone, said base station is operable to assign duplicate CDMA spreading codes to mobile stations in respective areas of the outer zone served by bridging stations that experience sufficiently low levels of cross-interference from each other's communications.

The present invention concerns communication of information within a wireless communications system. The invention is particularly, but not exclusively, concerned with the capacity of wireless communications systems in which data is transmitted in a cellular network.

The third generation (3G) collection of telecommunications standards, established in 1998 and managed by the European Telecommunications Standards Institute (ETSI), represent telecommunications implementations that offer facility for transfer of data in packet formats. The essence of the 3G Standard is that the packet format allows transfer of data, regardless of its nature. Thus, voice data and information based data can equally be transferred. Further, multimedia data can be transferred, as it is capable of being placed in a packet form and transferred accordingly.

In view of the general desire by users for transfer of increasing quantities of multimedia data, and/or voice data, with improved quality of service, there is a general and continuing requirement to seek improvements to present systems to enable greater throughput of packet data in a system.

In particular, a further portfolio of standards is currently in development, which is provisionally known as 4G (fourth generation). 4G is intended to extend 3G capacity by at least one order of magnitude, and to offer an entirely packet switched network. Whereas 3G is at least partially backwards compatible and thus 3G networks often include equipment compliant with previous, possibly non-packet based, standards, 4G network elements are intended to be entirely packet based. The data rate available in 4G is expected to be 100 Mbps (for high mobility users), and it is expected that this will develop to offer up to 1 Gbps (for low mobility users).

Clearly, developments in the field of telecommunications are normally expected to result in further increases in data throughput, and so no upper limit on the performance of the present invention can be inferred from the current understanding of the targets currently stated as being attainable.

The latter figure is most likely to be offered in respect of mobile devices in use by pedestrians, rather than those in use in motor vehicles. This is because data rates may be compromised by relatively rapid movement of a mobile device.

Within this context, the field of the present invention will now be described with reference to mobile communications systems based on a cellular structure. A cellular structure is imposed in order to provide coverage and capacity to users of mobile devices in the geographical area covered by the mobile communications service (the service area). Generally, a mobile communications system is designed such that, at any point in the service area, communication can be established between a base station and a mobile station within the service area. This is achieved by positioning base stations, perhaps in a regular pattern, or as near as possible taking into account physical features on the landscape, such that base stations generally govern respective cells of the cellular structure. The base stations are connected together to form a network backbone. This backbone is typically implemented by hard-wired connections.

In order for a mobile communications system to be useful, a minimum standard of quality of service must be offered to a subscriber. This entails satisfying various technical criteria in the nature of the communications between mobile stations and base stations in the system. Among these criteria are the coverage (i.e. the extent of the service area) and the capacity of the system. A subscriber will be dissatisfied with the quality of service if, while travelling, the mobile station enters a region with little or no coverage provided by communication with base stations and/or relays. Furthermore, a subscriber will also become dissatisfied if, when requesting a connection of a telephone call, the network is at capacity.

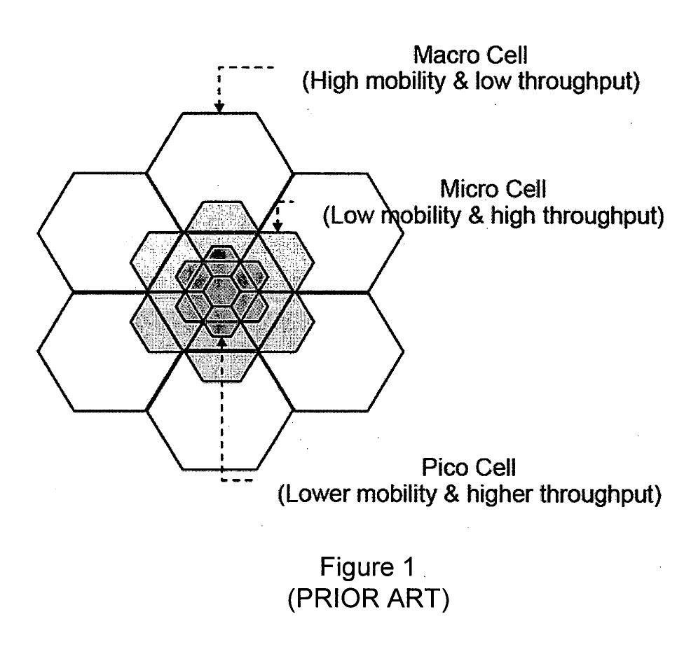

FIG. 1 illustrates an exemplary embodiment of an arrangement compliant with the 3G standard to provide improved coverage and enhanced capacity. It comprises, as illustrated, base stations (not shown), each base station having a beam pattern that, by convention is illustrated as substantially hexagonal (by virtue of six angularly spaced antennas). By virtue of these hexagonal beam patterns, a cellular field pattern can be established by virtue of regularly spaced base stations. This defines a wider, macro cell structure covering the service area. The macro cell provides the facility for communication between the base station of that cell and mobile stations within that cell with high levels of mobility but potentially low throughput of data. On top of that, a further array of base stations is deployed, each station offering a smaller coverage area. Again, in this exemplary arrangement, these smaller coverage areas are substantially hexagonal, so providing micro cells. A micro cell is characterised as offering higher throughput of data than in the macro cell, but at the expense of mobility of mobile stations within the micro cell. That is, micro cells are smaller, leading to more frequent instances of handover from one micro cell to another for a mobile station travelling at a given speed. Yet a further layer of cellular structure, with cells being still smaller than the micro cells, are provided by a further deployment of base stations. These cells are therefore termed picocells. Again, these further suffer with regard to mobility of mobile stations, in that the number of handovers required for a mobile station travelling at a given speed is far greater than with regard to a macro cell structure, but the intensity of transmission, and the adjacency to a base station allows greater throughput of data.

Therefore, the major disadvantages of this approach are the substantial increase in the cost of infrastructure due to the additional deployment of base stations on the network backbone, increased network structure due to the need to effect communication between the additional base stations, and the organisational requirements relating to the arrangement of base stations into macro-, micro- and pico-cell networks, and that throughput of data is variably limited, offering 384 Kbps for vehicle based mobile stations and 2 Mbps for stationary and near stationary mobile stations. Moreover, there is substantial signalling traffic on the backbone due to the handovers between cells and between overlapping layers of the cell hierarchy.

In addition, the wireless medium which is used in a mobile communications system with this cellular structure is somewhat unpredictable. This is due to the existence of multi-path effects brought about by the presence of physical structures in the landscape such as buildings and topographical features. Multi-path propagation can be deleterious to the successful operation of wireless communications in such a system, as it adds noise to a signal in the form of echoes of the signal itself. This noise can be sufficient to cause the termination of an active session such as a telephone call or streaming video. Such termination is highly undesirable from the point of view of the provider of a network service (the network operator) and certainly unacceptable from the point of view of the user of a mobile telephone device (the subscriber).

To address the problem of multi-path propagation and its impact on the quality of service experienced by a subscriber, it is known for a network operator to employ one or more relays, or repeaters. It will be appreciated that the terms ‘relay’ and ‘repeater’ are used interchangeably within the existing literature. These are positioned with respect to the base stations in the service area, in order to extend the coverage of the cellular parts of the service area associated with the base stations, so as to enhance the connectivity between the mobile station and the base station. A relay operates on the basis of blindly relaying received signals toward its respective base station. That is, a relay does not perform a decoding function and so cannot enhance any quality of service characteristics associated with the received data at the relay. Thus, a mobile station that is covered by the coverage of a relay simply receives a boost in signal strength.

Badruddin, N., and Negi, R., “Capacity improvement in a CDMA system using bridging,” in Wireless Communications and Networking Conference, 2004, WCNC. 2004 (IEEE, Volume: 1, 21-25 Mar. 2004, Pages 243-248) propose an enhanced relay system for CDMA based cells that also improves capacity. In this paper, Badruddin and Negi note that there is a significant interference problem for relays, when mobile stations (MSs) relatively near the relay are communicating directly with a more distant base station (BS) at high power. Such a situation may occur, for example, when an MS is 0.9 km from a base station while the relay is 1.0 km from the base station.

This interference impacts upon the capacity of the cell.

Badruddin and Negi propose a time division multiplexing (TDM) scheme wherein for each of three timeslots, direct communicating MSs in one 120° segment of the cell and relayed MSs in an opposite 120° segment of the cell occupy one time slot, forming a ‘bow-tie’ arrangement of reciprocal segments. This maximises the distance between direct communicating MSs and active relays and so minimises the interference between them. This results in greater capacity, but has the significant disadvantage that to maintain throughput in the TDM scheme requires transmissions at three times the original data rate to allow each 120° segment to directly and indirectly communicate in sequence.

To limit this problem, the paper then suggests using six 60° segments so that, for example, in a first time slot segments 1, 3 and 5 allow direct communication, while segments 2, 4 and 6 allow relayed communication. In a second time slot, these modes swap. Whilst this preserves the notion that the opposite segment is always in the opposite mode, now the adjacent segments are also in the opposite mode and so there is less mitigation of interference at each relay, reducing the improvement in capacity. In addition, this arrangement still uses a TDM scheme, now with two time slots, and so requires a doubling in data rate to maintain throughput.

Moreover, both schemes require exact timing between MSs, relays and the base station to operate the time division multiplexing, and require a significant increase in data rate.

Alternatively or in addition to attempts to physically avoid interference as described above, a scheme to increase cell capacity may adopt an improved multiple-access coding scheme that reduces multi-user interference between signals.

An example of such a scheme is code division multiple access (CDMA). In a CDMA spread spectrum communication system, a baseband signal is spread by mixing it with a spreading sequence of a much higher bit rate (referred to as the chip rate) before modulating the RF carrier. At the receiver, the baseband signal is recovered by feeding the received signal and the spreading sequence into a correlator and allowing one to slip past the other until a lock is obtained.

Such a system is described as code division multiplexed as the baseband signal can only be recovered if the initial spreading sequence code is known. A spread spectrum communication system allows many transmitters with different spreading sequences all to use the same part of the RF spectrum, with a receiver effectively tuning to the desired signal by selecting the appropriate spreading sequence.

This is possible because the spreading sequences, or codes, are selected to be mutually orthogonal. Codes are said to be orthogonal when their inner (scalar) product is zero. E.g., the sequences (1, 1, 1, 1) and (1, 1, −1, −1) are orthogonal as (1*1)+(1*1)+(1*−1)+(1*−1)=0. By using such mutually orthogonal spreading codes, the correlator will only strongly respond (lock on) when the correct spreading code interacts in sync with the received signal. It is then straightforward to recover the original data.

The total number of users N, therefore, is limited by the number of available orthogonal spreading sequences, known as the spreading factor SF. Thus in general N=SF.

However, one shortfall of this approach is the requirement that the information rate is the same for all users, as their data is modulated using a common coding scheme. For services such as 3G, and in future 4G, that provide a range of communication options, this is a severe restriction.

Orthogonal variable spreading factors (OVSF) provide a solution to this problem, by allowing spreading codes of different lengths for different users, whilst maintaining mutual orthogonality. As the chip rate remains the same, shorter spreading codes per information bit allow for a higher information transmission rate.

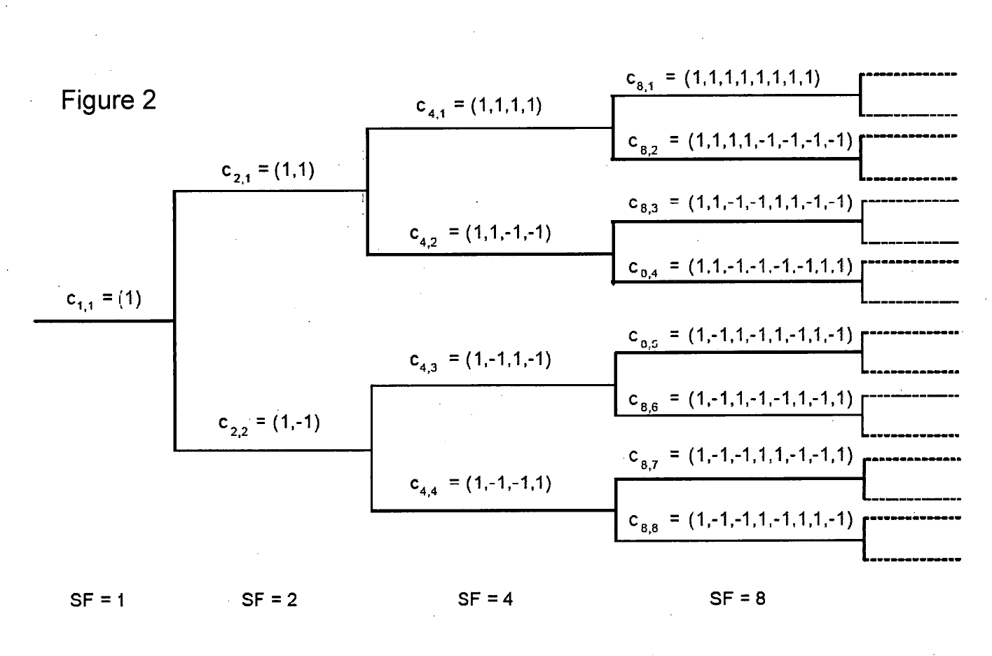

Referring now to FIG. 2, OVSF codes can be generated using a code tree. Each stage of the tree has a different spreading factor, denoted as SF=1, SF=2, SF=4, and SF=8. Only these first four factors have been shown for clarity, but it will be appreciated that more stages of the tree are possible, with consequently higher spreading factors.

The codes bifurcate as the tree grows according to the following rules:
i. The first element in the tree is 1.
ii. For each element, there are two possible sub-elements, referred to herein as the top and bottom sub-elements.
iii. The top sub-element is constructed by repeating the parent sub-element twice. Thus, the top sub-element of (1) would be (1,1).
iv. The bottom sub-element is constructed by concatenating the parent sub-element with the inverse of itself. Thus, the bottom sub-element of (1) would be (1, −1).

By convention, each code is referred to by its spreading factor and its ordinal within the code set. Thus, referring to FIG. 2, code c_{4,3}=(1, −1, 1, −1).

The resulting codes have the property that they are mutually orthogonal to codes on other branches of the tree than their own, regardless of length. However, codes are not orthogonal with their own children.

The result is variable trade-off between the number of users and the information rate available to each user. Thus, for example, a high information rate user assigned code c_{2,1} prevents access for two medium rate users on codes c_{4,1} and c_{4,2}, or access for four low rate users on codes c_{8,(1,2,3,4)}.

In principle, this trade-off still preserves the total amount of information being transmitted in the available bandwidth. However, coupling the orthogonality constraint to the topology of the code tree introduces a further problem;

In FIG. 2 the maximum code capacity shown is N=SF=8. For the purpose of example, suppose that two low information rate users are communicating using SF=8 codes c_{8,1} and c_{8,8}, and one medium information rate user is communicating using a SF=4 code c_{4,3}. The remaining capacity on the system is for four SF=8 users, on c_{8,2}, c_{8,5}, c_{8,6} and c_{8,7}. This is equivalent in information to one high information rate SF=2 user, as noted previously. However, an SF=2 user who wishes to communicate in this cell will be unable to, as there is no sub-branch of an SF=2 code that does not already support at least one occupant, and whose code would therefore not be orthogonal.

By contrast, if the SF=2 user had joined first and been assigned c_{2,1}, then the other three users could also have joined using c_{4,3} and c_{8,7} and c_{8,8}.

Clearly therefore OVSF cannot guarantee an optimal use of resources, as the level of occupancy is determined by the random order in which users start communications within the cell.

Other means to improve code capacity also exist. To increase the number of simultaneous users of a cellular system, the data can be further spread by a scrambling code such as a Gold code. Scrambling codes are typically used to differentiate adjoining cells, allowing each base station to use the spreading code set independently of its neighbours.

The scrambling code does not change the signal bandwidth, but allows signals to or from different users to be distinguished from one another. The scrambling code is used on top of the spreading code. Thus, a signal at the chip rate of the spreading code is then multiplied by the scrambling code to produce a scrambled signal at the same chip rate.

The number of users within one cell can also be increased by such a method, as seen in Vanhaverbeke, F., et. al., ‘Increasing CDMA capacity using multiple orthogonal spreading sequence sets and successive interference cancellation’, IEEE Intl. Conf. Comm., 2002, vol. 3, pp 1516-1520. In this paper, pseudo random scrambling codes were applied to parallel sets of N code users, in order to make each set resemble increased noise to each other. The user data in each set was then decoded using an iterative noise estimation technique based on the known scrambling codes. Whilst this improves capacity, it has an impact on bit error rate (and thus, ultimately, quality of service) due to the increased signal to noise ratio for each user.

Thus, there appears to be scope for an improved approach to cell capacity, based upon reducing interference through cell architecture, data coding techniques, or an interaction of the two.

The present invention intends to provide such an approach.

In a first aspect of the present invention, a cellular base station is arranged in operation to communicate directly with mobile stations that are located within an inner zone of a cell, where said inner zone is substantially defined by a circumference formed by a plurality of bridging stations deployed about said base station, and wherein the base station is further operable to communicate via said bridging stations with mobile stations that are located within an outer zone of the cell lying predominantly outside said circumference.

In a configuration of the above aspect, the base station is additionally operable to determine which CDMA spreading codes may be duplicated in use with mobile stations in coverage areas served by bridging stations that receive sufficiently low signal leakage from each other's regions.

In a configuration of the above aspect, the base station is operable to assign duplicate CDMA spreading codes for communications with mobile stations located in coverage areas served by substantially diametrically opposed bridging stations.

In a configuration of the above aspect, in operation one or more scrambling codes are also applied after the spreading code.

In another aspect of the present invention, a bridging station comprises one or more directional antennas operable to generate a coverage area in an outer zone, the outer zone lying predominantly outside a circumference defined with respect to a base station and approximately coincident with said bridging station, the bridging station being arranged in operation to descramble a receive signal using any or all of a base station specific scrambling code, and a bridging station specific scrambling code.

In a configuration of the above aspect, the bridging station is further operable to combine a multi path signal and to code multiplex said combined signal with a common pilot channel.

In a configuration of the above aspect, the bridging station is yet further operable to rescramble a signal using any or all of a base station specific scrambling code, and a bridging station specific scrambling code.

In an aspect of the present invention a communication network comprises at least a first region serviced by a base station, the base station being additionally surrounded by a plurality of bridging stations so defining a circumference approximately coincident with said bridging stations, the bridging stations being directionally sensitive beyond said circumference with respect to the base station, so forming an inner zone predominantly within the circumference that is serviced by the base station, and an outer zone predominantly beyond the circumference serviced by the plurality of bridging stations, and wherein the base station is operable to determine which CDMA spreading codes may be duplicated in use with mobile stations in coverage areas served by bridging stations that reciprocally receive sufficiently low power signals from each others communications.

In an aspect of the present invention, a data carrier comprises computer readable instructions that when interpreted by a computer, cause it to operate as a base station as disclosed herein.

In another aspect of the present invention, a data carrier comprises computer readable instructions that when interpreted by a computer, cause it to operate as a bridging station as disclosed herein.

Embodiments of the present invention will now be described by way of example with reference to the accompanying drawings, in which:

FIG. 1 is a schematic diagram of a 3G cellular network and resulting coverage scheme known in the art.

FIG. 2 is a schematic diagram of an OVSF spreading code tree as known in the art.

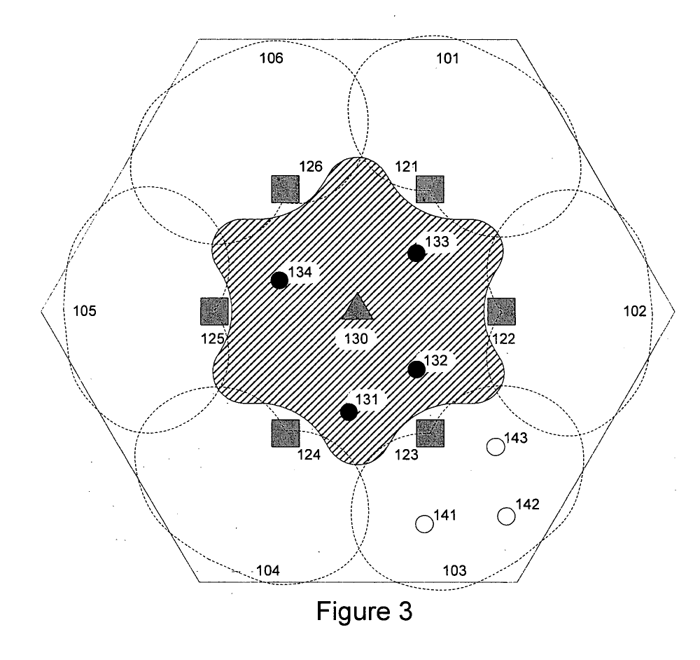

FIG. 3 is a schematic diagram of a base station and bridging stations in accordance with an embodiment of the present invention illustrating the resulting areas of coverage.

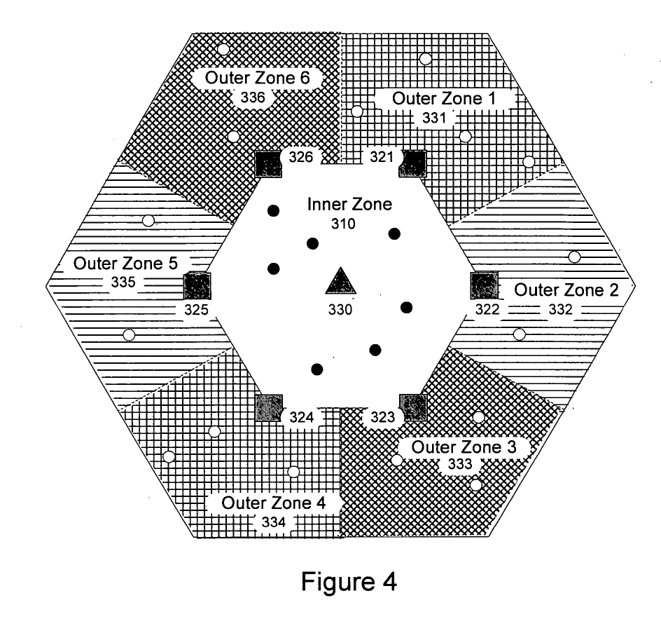

FIG. 4 is a schematic diagram of a base station and bridging stations in accordance with an embodiment of the present invention, illustrating communication between the base stations and bridging stations.

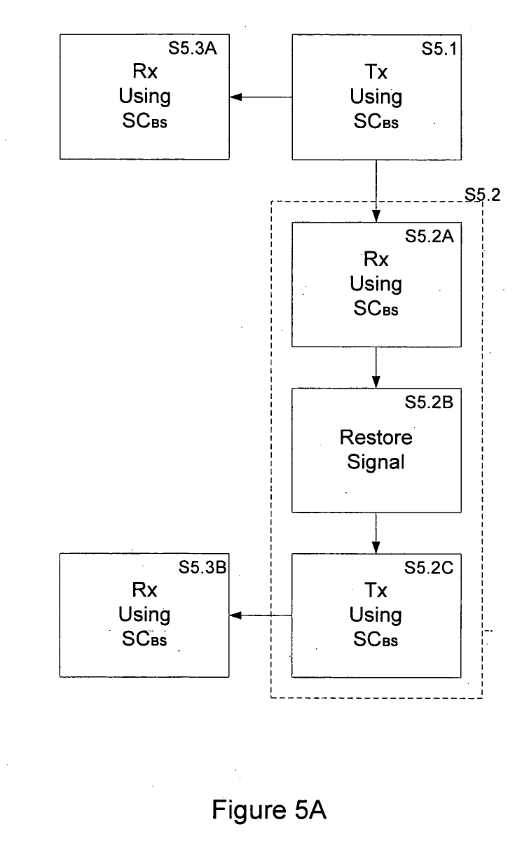

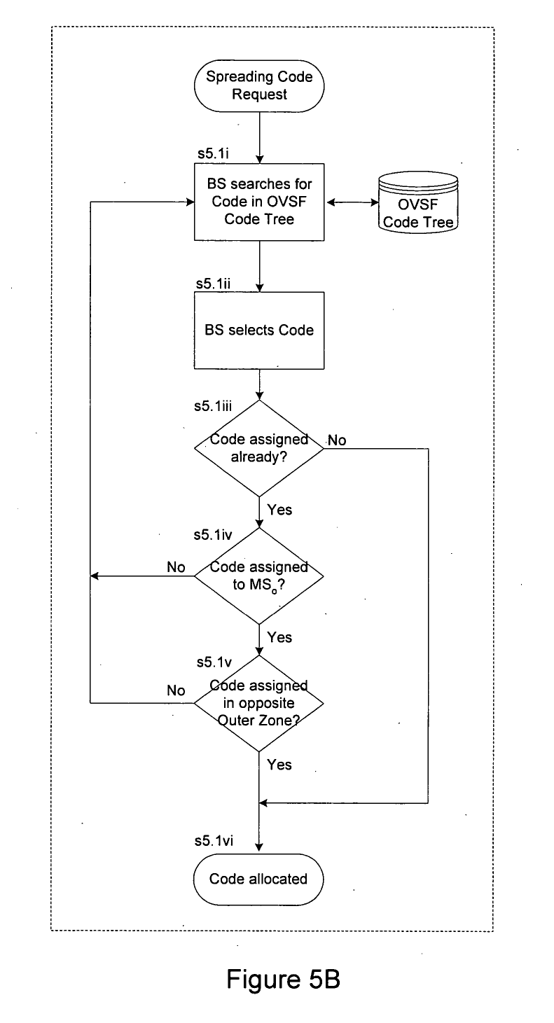

FIG. 5A is a flow diagram of a method of communication in accordance with an embodiment of the present invention.

FIG. 5B is a flow diagram of a method of code allocation in accordance with an embodiment of the present invention.

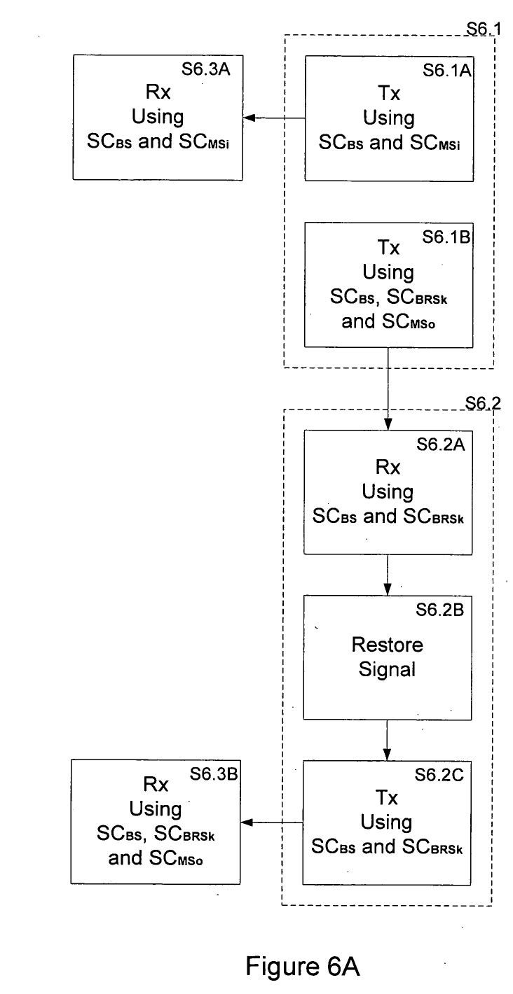

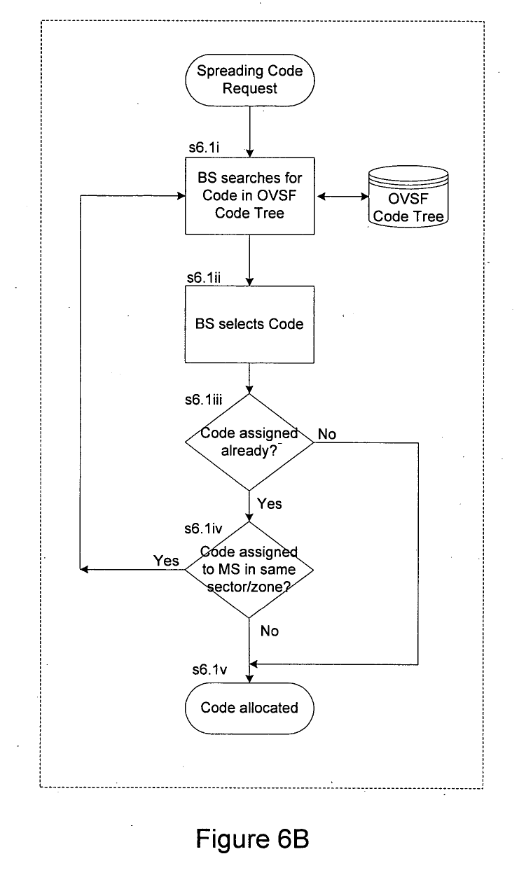

FIG. 6A is a flow diagram of a method of communication in accordance with an embodiment of the present invention.

FIG. 6B is a flow diagram of a method of code allocation in accordance with an embodiment of the present invention.

A wireless communication system is disclosed. In the following description, a number of specific details are presented, by way of example, in order to provide a thorough understanding of embodiments of the present invention. It will be apparent, however, to a person skilled in the art that these specific details need not be employed to practice the present invention.

Referring now to FIG. 3, in an embodiment of the present invention, a new cell architecture comprises a base station (BS) 130 connected to the cellular network backbone (not shown), for example via a wireline connection to a mobile switching centre (not shown). Deployed at a distance around the base station (BS) are bridging stations (BRS) 121-126 that are not connected to the backbone.

The bridging stations 121-126 comprise beam-forming antenna arranged to provide communication in a substantially outward direction in relation to the base station 130. Thus each bridging station provides a respective outward facing coverage area 101-106.

In consequence, mobile stations (MS) 131-134 located between the base station and the deployed bridging stations only perceive the base station 130 and so communicate with it directly.

In contrast, mobile stations 141-143 located beyond the deployed bridging stations, but within one of the outward facing coverage areas 101-106, perceive both the BS 130 and one or more BRSs, but select the BRS with the strongest signal (for example, on an broadcast channel) with which to communicate.

The effect is to create two zones within the cell; an inner zone where an MS only sees the base station and so communicates directly with it (denoted by the hatched area in FIG. 3), and a segmented outer zone comprised of coverage areas 101-106 where an MS elects to communicate with a respective bridging station.

Advantageously, the directionality of the bridging stations 121-126 means that not only do MSs in the inner zone not detect the bridging stations, but the bridging stations 121-126 also do not detect MSs from the inner zone, and so do not suffer interference from these MSs.

Similarly advantageously, MSs in the outer zone will adjust their power output to communicate with the closest BRS, and so minimise the interference they cause at the BS 130 and to other BRSs.

Thus, a significant overall reduction in interference and corresponding increase in capacity is achieved without the disadvantages of either time division multiplexing or hierarchical arrangements of sub-cells, as experienced in the prior art.

It will be understood that in practice, some incidental signals from each zone may be perceived in the other. For example, a (heavily attenuated) signal from an MS in the inner zone may reach a BRS due to back-scattering by a building in the outer zone. Similarly, whilst most directional antennas are predominantly sensitive in the preferred range of direction, there may be residual sensitivity in other directions. Thus a BRS may detect an MS from the inner zone, but at a significantly attenuated sensitivity when compared to an MS in its own outward facing coverage area. Conversely an MS in the inner zone may detect a BRS, but as a comparatively faint signal.

Thus in practice, the bridging stations can be thought of as being deployed to form a circumference about the base station, wherein the bridging station signal strength within the circumference is insignificant, and wherein a bridging station's signal strength outside the circumference is predominant within each respective bridging station's coverage area. Consequently, the area within the circumference forms the inner zone, and the bridging station coverage areas form the outer zone.

In an embodiment of the present invention, the bridging stations 121-126 facilitate communication between an MS in the outer zone and the BS 130 in the inner zone by acting as if part of a multi-hop network, allowing communication between the MSs in the outer zone and the BS 130 via hops to the relevant BRS. Mechanisms for establishing multi-hop networks are well known in the art. Due to the fixed nature of the bridging stations, however, it is anticipated that only two hops (from MS to BRS and from BRS to BS) are necessary.

The beneficial reduction in interference caused by creating an inner and segmented outer zone within the cell can be further exploited by adaptation of CDMA coding techniques.

Referring now to FIG. 4, a schematic representation of the arrangement shown in FIG. 3 is presented for clarity, comprising an inner zone 310 and six segments of the outer zone 331-336, served by corresponding bridging stations 321-326.

Advantageously, this arrangement allows for a significant increase in overall CDMA code capacity.

In FIG. 4, the segments are shaded as opposing pairs (331, 334), (332, 335), (333, 336). These opposing pairs will experience the smallest cross-interference in the cell, as they direct their coverage away from each other and are also physically separated by the diameter of the inner zone 310.

Thus, in an embodiment of the present invention, the base station assigns duplicate spreading codes in opposing pairs of outer zone segments. Then, for a total of SF possible spreading codes, potentially 2N MSs can communicate with the base station if one assumes a substantially uniform distribution of MSs within the outer zone. It will be appreciated that more generally, 2(N−K) MSs coud communicate from the outer zone, where K is the number of MSs using spreading codes in the inner zone.

The corresponding method of communication comprises the steps of:
i. the BS communicating with MSs in the outer zone via a respective BRS, and;
ii. the BS assigning duplicate spreading codes for communication with MSs in substantially opposite segments of the outer zone.

In addition, the cell architecture disclosed previously provides greater flexibility when using OVSF codes. Two specific examples of the method of communication with OVSF codes will now be discussed in detail.

Referring to FIG. 5A, in an embodiment of the present invention for code re-use when only base station scrambling codes are used in an OVSF-CDMA system, it is assumed that users are substantially uniformly distributed throughout the cell, including the outer zone, and that rake receiver processing is available within the bridging stations. It is also assumed that communication between the bridging stations and base station is by a comparatively narrow directional beam. MSs in the inner zone are referred to as MSᵢ, while MSs in the outer zone are referred to as MSₒ. Bridging stations in this example are indexed 1 . . . k . . . 6.

The operation of each step is as follows.

Step 5.1—Transmission from base station:

The BS 310 transmits to all MSᵢ, all MSₒ and all the BRS for which OVSF codes and the BS's scrambling codes SC_{BS} are used.
   Where
      The SC_{BS} code is the same for all MSs and BRSs served by the BS;
      OVSF codes are used for MS separation irrespective of which zone they are in, and;
      OSVF codes are selected for use or re-use as appropriate according to where each MS resides.
         Step 5.2—Reception by BRS k:
         Step 5.2A
BRSₖ descrambles the signal using SC_{BS} codes.
   Step 5.2B
The signal is then processed to eliminate interference from the common channels of MSᵢs.
   It will be appreciated that with a fixed BS to BRSₖ link, a good channel estimate is possible, enabling a good estimate of the channel interference and so a good re-estimation of the signal.
A rake combiner combines the multi-path signal received at BRSₖ.
A common pilot channel (CPICH) is code multiplexed with the rake combined signal.
   It will be appreciated that the CPICH transmitted by the BS is intended to encompass the cell boundary, and so is of relatively high power, causing relatively high interference in a time-dispersive environment. However, by splitting the cell into inner and outer zones, the relative power level of CPICH to cover each zone can be lowered.
      Step 5.2C
The BRSₖ rescrambles the signal using SC_{BS} codes.
   Step 5.3A—Reception by MSᵢ in the inner zone:
MSᵢ descrambles the direct signal from the BS using SC_{BS} codes, before de-spreading the signal.
   Step 5.3B—Reception by MS_{o,k} in the outer zone:
MS_{o,k}, the MSs in the outer zone segment served by BRSₖ, descrambles the signal from the BRSₖ using SC_{BS} codes, before de-spreading the signal.

Referring now also to FIG. 5B, the allocation of spreading codes in step 5.1 above is depicted in more detail. Upon receiving a request for a spreading code, the base station 310 searches the code tree for a code to assign in steps s5.1i and s5.1ii. In steps s5.1iii the BS checks whether the code has already been assigned. If not, then the BS assigns it in step s5.1vi. Otherwise, in steps s5.1.iv and s5.1v, the BS checks whether the code has been assigned to an MS in the opposite sector of the outer zone to that of the MS currently requesting a new code. If so, the code is also allocated to the requesting MS. If not, the BS returns to step s5.1i to search for another code.

The example problem of accommodating an SF=2 user in a cell as described previously can now be revisited, adding the effects of inner and outer zoning.

As before, assume the maximum code capacity is N=SF=8. Now, assume the two low information rate (SF=8) code users are assigned as follows:

MS(1)_{o,1} (User 1 in outer zone segment 1) uses code c_{8,1}, and;

MS(2)_{o,4} (User 2 in outer zone segment 4) uses code c_{8,8}.

Similarly, assume that the medium information rate (SF=4) code user MS(3)ᵢ (User 3 in inner zone) uses code c_{4,2}. It will be appreciated that these are the same codes as used in the original example.

Now, if a new high-information rate (SF=2) user wishes to join in outer zone segment 1 then, in contrast to the original example, the base station is now able to assign the code c_{2,2} to the user, because the non-orthogonal code c_{8,8} already assigned is operating in the opposite outer segment.

Thus, the sectorisation of the cell into zones and segments by the above arrangement of bridging stations provides increased flexibility, by partially decoupling the topology of the OVSF code tree according to the placement of users within the cell.

Referring now to FIG. 6A, in another embodiment of the present invention in which additional scrambling codes are also applied in an OVSF-CDMA system, it is assumed that users are substantially uniformly distributed within the cell, including the outer zone, and that rake receiver processing is available within the bridging station. It is also assumed that in this case, the base station communicates with the bridging stations with an omnidirectional beam, so necessitating the additional level of scrambling. The bridging stations each still use a narrow beam to communicate with the base station, however. MSs in the inner zone are referred to as MSᵢ, while MSs in the outer zone are referred to as MSₒ. Bridging stations are indexed 1 . . . k . . . 6.

The operation of each step is as follows.

Step 6.1—Transmission from base station:

The BS transmits to all MSs and BRSs.
   Step 6.1A
      The MSᵢ transmission is spread using SC_{BS} and SC_{MSi} codes where SC_{BS} are base station scrambling codes, and SC_{MSi} are inner zone mobile station OVSF spreading codes, resulting in two layers of codes.
   Step 6.1B
      The MSo transmissions use SC_{BS}, SC_{BRSk} and SC_{MSo} codes, where SC_{BRSk} are bridging station scrambling codes and SC_{MSo} are outer zone mobile station OVSF spreading codes, resulting in three layers of codes.
         Step 6.2—Reception at bridging station k:
         Step 6.2A
BRSₖ descrambles the signal using SC_{BS} and then SC_{BRSk}.
   Step 6.2B
As before, the common channel interference can be mitigated at this point.
As before, a rake combiner combines the multi-path signal received at BRSₖ.
As before, a common pilot channel (CPICH) is code multiplexed with the rake combined signal.
   Step 6.2C
The BRSₖ rescrambles the signal using SC_{BRSk} and SC_{BS}.
   SC_{BRSk} can be the same as that originally assigned by the BS, or a new scrambling code.
      Step 6.3A—Reception in the inner zone:
The MSᵢ descrambles the signal using SC_{BS}, and then de-spreads the signal using SC_{MSi}.
   Step 6.3B—Reception in the outer zone:
MS_{o,k} (MSs in the outer zone served by BRSₖ) descramble the signal with SC_{BS} and then SC_{BRSk} and then de-spreads the signal using SC_{MSo}.

Thus, by way of example, given one MSᵢ and two MSₒs, then the signal transmitted from the BS is

```
SC_{BS} × ( MS₍₁₎ᵢ × SC_{MSi} +
              SC_{BRSk} × ( MS_{(2)o,k} × SC_{MSo,k} + MS_{(3)o,k} × SC_{MSo,k})
        )
```

Where SC_{BS} are the base station's scrambling codes, SC_{MS} are the mobile station spreading codes, and SC_{BRSk} are the bridging station scrambling codes.

Referring now also to FIG. 6B, the allocation of spreading codes in step 6.1 A/B above is depicted in more detail. Upon receiving a request for a spreading code, the base station 310 searches the code tree for a code to assign in steps s6.1i and s6.1ii. In steps s6.1iii the BS checks whether the code has already been assigned. If not, then the BS assigns it in step s6.1v. Otherwise, in step s6.1.iv, the BS checks whether the code has been assigned to an MS in the same sector of the cell as that of the MS currently requesting a new code. If so, the BS returns to step s6.1i to search for another code. If not, then in step s6.1v the code is also allocated to the requesting MS.

In this case, the whole of the OVSF code tree is available in each of the outer zone segments, because each outer zone segment is distinguished by its own BRSₖ scrambling code. The whole of the code tree is also available to the inner zone. The result is a significant increase in capacity within the cell.

It will be appreciated that spreading sequences/codes other than OVSF codes would benefit from this arrangement.

In a further embodiment of the present invention, if BS to BRS and BS to MS frequency bands are different, then the link between the BRS and BS can also independently use a full set of spreading codes in parallel with MS communication. For example, communication with mobile stations may be in a 4G-licensed band, whilst communication between base and bridging stations may be centred at a higher frequency suitable for higher bandwidth communications.

It will be appreciated that, whilst in FIGS. 3 and 4 six bridging stations are shown evenly distributed and each covering an area of similar size, in practice any suitable number of bridging stations may be deployed and may have substantially outward looking coverage areas applicable to the topology and traffic requirements within the overall cell region. Thus the circumference identifying the inner and outer zones may be arbitrary in shape, and the density of bridging stations may vary to create micro-cell and pico-cell sized coverage zones where applicable.

In consequence, it will apparent to a person skilled in the art that duplicate CDMA spreading codes can be assigned to segments of the outer zone that are not in exact opposition to each other (for example, where there are an odd number of bridging stations, or one comparatively large outer zone segment is in diametric opposition to two relatively small outer zone segments).

Thus, in an embodiment of the present invention, the base station is free to assign duplicate spreading codes in respective outer zone segments that have sufficiently low levels of cross-interference, and is not restricted merely to opposing segments.

Similarly, in an embodiment of the present invention, it is not necessary for the coverage area of the BS to be maintained so as to match the extent of the cell, as the BRSs provide communication links with MSs in the outer zone. In consequence, the base station power management may be configured to provide the smallest coverage area that maintains continuity of coverage with the plurality of bridging stations.

It will be appreciated that the use of bridging stations in conjunction with a CDMA scheme provides a number of advantages.
i. The topological differentiation of users by the use of bridging stations physically substantially isolates signals in opposing outer zone segments. Consequently CDMA codes may be re-used in these opposing segments, so potentially doubling capacity.
ii. The topological differentiation of users by the use of bridging stations substantially isolates signals in the inner zone from the outer zone. Where interference from MSs in the outerzone is sufficiently low at the BS, then CDMA codes may also be used in the inner zone independently of the outer zone.
iii. The topological differentiation of users by the use of bridging stations allows greater flexibility when assigning OVSF codes to new users, and in particular higher information rate codes. Transmission at higher information rates for the same chip rate provides improved service and helps to prolong battery life in portable devices by reducing transmission times.
iv. The topological differentiation of users by the use of bridging stations allows separate scramble codes to distinguish sectors of the cell, much as scramble codes currently distinguish between whole cells.

Each of these advantages, taken separately or in combination, serves to improve the capacity and flexibility of cells using CDMA communication.

It will be clear to a person skilled in the art that CDMA is an umbrella term for code division multiplexing techniques in general, and encompasses variants such as W-CDMA and CDMA-2000.

Similarly, it will be clear to a person skilled in the art that the present invention is suited to other wireless architectures where mobile communications devices link to a central station that in turn links to a wireline infrastructure, such as wireless local loop.

It will be clear to a person skilled in the art that embodiments of the present invention may be implemented in any suitable manner to provide suitable apparatus or operation; Thus, a base station may consist of a single discrete entity, multiple entities added to a conventional host device such a s a computer, or may be formed by adapting existing parts of a conventional host device such as a computer. Alternatively, a combination of additional and adapted entities may be envisaged. For example, components used in the manufacture of base stations may be used in the construction of bridging stations when suitably reconfigured. Thus adapting existing parts of a conventional device may comprise for example reprogramming of one or more processors therein. As such the required adaptation may be implemented in the form of a computer program product comprising processor-implementable instructions stored on a storage medium, such as a floppy disk, hard disk, PROM, RAM or any combination of these or other storage media or signals.

1. A base station for wireless communication arranged in operation to directly communicate with mobile stations located within an inner zone of a cell, the inner zone lying predominantly within a circumference formed by a plurality of bridging stations deployed around said base station, the base station further arranged in operation to indirectly communicate via said bridging stations with mobile stations located within an outer zone of the cell lying predominantly outside said circumference.

2. A base station in accordance with claim 1, wherein in operation the base station assigns duplicate CDMA spreading codes to mobile stations in respective areas of the outer zone served by bridging stations that experience sufficiently low levels of cross-interference from each other's communications.

3. A base station in accordance with claim 2, wherein the bridging stations are substantially diametrically opposed within the cell.

4. A base station in accordance with claim 2, wherein communications are code scrambled.

5. A base station in accordance with claim 1 wherein in operation the base station applies a base station specific scrambling code to CDMA signals in communications with mobile stations and bridging stations within its cell.

6. A base station in accordance with claim 5 wherein in operation the base station applies an inner zone mobile station scrambling code to CDMA signals in communications with mobile stations in the inner zone.

7. A base station in accordance with claim 5 wherein in operation the base station applies an outer zone mobile station scrambling code to CDMA signals in communications with mobile stations in the outer zone.

8. A base station in accordance with claim 5 wherein in operation the base station applies a bridging station specific scrambling code to CDMA signals in communications with respective bridging stations.

9. A bridging station for wireless communication comprising one or more directional antennas operable to generate a coverage area lying predominantly outside a circumference, said circumference defined with respect to a base station and substantially coincident with said bridging station, and wherein the bridging station is operable to descramble any or all of
i. A base station specific scrambling code, and
ii. A bridging station specific scrambling code.

10. A bridging station in accordance with claim 9 further operable to combine a multi path signal and to code multiplex said combined signal with a common pilot channel.

11. A bridging station in accordance with claim 9 further operable to rescrambloe a signal using any or all of
i. a base station specific scrambling code, and;
ii. a bridging station specific scrambling code.

12. A communication network comprising at least a first region serviced by a base station, and further comprising a plurality of bridging stations deployed around the base station so defining a circumference about said base station, wherein each bridging station comprises one or more directional antennas operable to generate a coverage area lying predominantly outside said circumference, so forming in operation an outer zone predominantly outside said circumference and serviced by said bridging stations, and an inner zone predominantly within said circumference and serviced by said base station, and wherein said base station is operable to assign duplicate CDMA spreading codes to mobile stations in respective areas of the outer zone served by bridging stations that experience sufficiently low levels of cross interference from each other's communications.

13. A data carrier comprising computer readable instructions that, when loaded into a computer, cause the computer to operate as a base station in accordance with claim 1.

14. A data carrier comprising computer readable instructions that, when loaded into a computer, cause the computer to operate as a bridging station in accordance with claim 9.
